(19) United States
(12) Patent Application Publication
(10) Pub. No.: US 2022/0038447 A1
(43) Pub. Date: Feb. 3, 2022

(54) SYSTEMS AND METHODS FOR AUTONOMOUS PROGRAM DETECTION AND MANAGEMENT

(71) Applicant: Citrix Systems, Inc., Fort Lauderdale, FL (US)

(72) Inventors: Rakesh Kumar Thangellapalli, Milpitas, CA (US); Rama Rao Katta, Freemont, CA (US); Kasirao Velugu, Bengaluru (IN); Praveen Dandin, Freemont, CA (US); Aman Agrawal, Bangalore (IN); Seth K. Keith, Scotts Valley, CA (US); Ratnesh Singh Thakur, San Jose, CA (US); Josephine Suganthi Joseph Leo, SunnyVale, CA (US)

(21) Appl. No.: 16/944,767

(22) Filed: Jul. 31, 2020

(51) Int. Cl. H04L 29/06

(52) U.S. Cl. CPC H04L 63/0807; H04L 63/0876; H04L 63/1458; H04L 63/126; H04L 63/0892

(57) ABSTRACT

Systems and methods for autonomous program management include a device which may receive a first request from a client for a server. The device may transmit one or more data packets to the client. The data packet(s) may include a response to the request from the server and an attribute collector script which executes on the client to automatically transmit one or more attributes corresponding to at least one of the client or a browser of the client to the device. The device may receive a second request from the client which includes one or more attributes collected using the attribute collector script. The device may determine whether the client is associated with an autonomous program using the attribute(s). The device may block one or more subsequent requests from the client to the server responsive to determining that the client is associated with an autonomous program.

### BACKGROUND

In a network environment, a plurality of client devices can be connected to one or more servers to access applications provided by the servers. As a level of traffic to a server increases, the quality of service the server can provide may decrease. For example, the server can be overloaded or have insufficient resources to handle the traffic. The traffic can include attempts to access the application or server from malicious programs or actors. The overload condition can result in service disruptions or failures.

### SUMMARY

The present disclosure is directed towards systems and methods for bot (or autonomous program) management. In some aspects, the present disclosure is directed towards a device (and corresponding method) for client fingerprinting in distributed systems in real-time.

Bots or autonomous programs (e.g., web robots) are prevalent in today's network traffic. Bots can imitate or replace human user behavior and perform tasks on a faster pace than a human user of a client device. However, the traffic from bots can overwhelm and/or slow down a networks resources resulting in disrupted or delayed service to human users of one or more client devices. The bots can include malicious or attack bots programmed to break into accounts, steal information and/or perform malicious activities. Thus, it is increasingly important to detect and differentiate traffic and/or connections from bots versus a human user.

According to the embodiments described herein, a device may employ, use, or leverage a client “fingerprinting technique” to determine whether a connection is from an autonomous program or a human being. In some embodiments, the device may perform fingerprinting by inserting an attribute collection script (or JavaScript snippet) into an HTML Response served to a client. The attribute collection script, when invoked by a browser on the client, collects attributes of the browser and client and sends those attributes in an HTTP POST request to the device. The device may analyze the attributes to whether the connection appears to be from an autonomous program or a human being. Also, even the lack of this request points out that the connection may be from a Bot.

When the connection is determined to be from a human being, the device generates a unique identifier (e.g., a unique fingerprint identifier or cookie) corresponding to the client. The device may generate the unique identifier including various encrypted information corresponding to the session, and transmits the cookie with a subsequent response and a set-cookie HTTP header. The unique identifier may be unique for that client and the session, including the browser used. The device may compute a cookie. In some embodiments, the device may generate a cookie by computing a hash (e.g., an SHA 1 hash) using various attributes, such as browser plugins, browser fonts, UserAgent, browser CanvasPrint, screen resolution, color depth, and CPU. The cookie may thus contain information or data which can help the device identify a session and client, including the unique identifier for the client. The cookie may include cookie data appended by a cookie sign (e.g., <cookie data><cookie sign>). The cookie sign is generated by computing a hash-based message authentication code (HMAC) on the cookie data with a key shared between all of the nodes (e.g., HMAC(<cookie data>, Key)). The cookie may be versioned so that, for a specific version, a length of the cookie data and an offset of the cookie sign is known.

For subsequent requests from the client, the device may validate the cookie to verify that the cookie is valid for the particular client, no tampering has occurred due to an autonomous program, and that the cookie is received as expected from a human being normally using a browser. The cookie may contain information which can help the device identify the session and the client, including the uniquely generated fingerprint ID. The device may validate the cookie to determine if any tampering has occurred. Where the cookie has been tampered with, modified, or otherwise altered, or if the device does not receive a cookie following a predetermined amount of grace requests, the device may determine that the connection is from an autonomous program.

The device may validate a cookie by first validating that determined length of the cookie from the client has a length which corresponds to the particular version. The device may then determine the cookie sign by computing the HMAC on the cookie data. The device may compare the computed cookie sign to the one received from the client. If the cookie signs match, the device may determine that the cookie is valid and has not been tampered with. If the cookie has been tampered with (or if no cookie has been received after a predetermined amount of grace requests), the device may determine that the connection is from an autonomous program. In some embodiments, where the cookie is tampered with or expired, the device may challenge the client again with the device fingerprinting technique as described above, to ensure that the client is still associated with a human rather than an autonomous program. According to the systems and methods described herein, the autonomous program management may provide for bot functionality across a network or cluster of devices in real-time.

In one aspect, this disclosure is directed to a method. The method may include receiving, by a device intermediary to a client and a server, from the client, a first request for the server. The method may include transmitting, by the device, one or more data packets to the client. The one or more data packets may include a response to the request from the server and an attribute collector script configured to execute on the client to automatically transmit, to the device, one or more attributes corresponding to at least one of the client or a browser of the client. The method may include receiving, by the device, from the client, a second request including one or more attributes collected using the attribute collector script. The method may include determining, by the device, using the one or more attributes, whether the client is associated with an autonomous program. The method may include blocking, by the device, responsive to determining that the client is associated with an autonomous program, one or more subsequent requests from the client to the server.

In some embodiments, transmitting the one or more data packets including the attribute collector script is performed responsive to the first request not including a cookie from the client. In some embodiments, the method further includes transmitting, by the device, responsive to determining that the client is not associated with an autonomous program, the one or more subsequent requests to the server. In some embodiments, the method further includes transmitting, by the device, the first request received from the client to the server. The method may further include receiving, by the device, from the server, the response to the first request. The method may further include generating, by the device, the one or more data packets using the response to the first request by inserting the response and the attribute collector script into the one or more data packets.

In some embodiments, the response is a first response, and the method further includes receiving, by the device from the server in response to the client not being associated with an autonomous program, a second response to the second request. The method may further include generating, by the device, a cookie associated with a session between the client and the server. The method may further include transmitting, by the device, to the client, the second response and the cookie. In some embodiments, the method further includes receiving, by the device from the client, one or more subsequent requests for the server, the one or more subsequent requests including the cookie. The method may further include validating, by the device, the cookie included the one or more subsequent requests for the server, prior to transmitting the one or more subsequent request to the server via the session. In some embodiments, the method may further include determining, by the device, that the cookie included in a subsequent request is expired or invalid.

In some embodiments, the method further includes, responsive to determining that the cookie included in the subsequent request is expired or invalid, performing one of generating, by the device, a new cookie for the client, or blocking the subsequent request from being transmitted to the server responsive to the cookie being expired or invalid. In some embodiments, the method further includes transmitting, by the device, the one or more subsequent requests responsive to a count of grace requests in which the cookie is expired or invalid is less than a threshold. In some embodiments, determining that the cookie is invalid includes storing, by the device, in one or more data storage devices, a first value associated with the cookie associated with the session, computing, by the device, a second value corresponding to the cookie received with the subsequent request from the client, comparing, by the device, the first value stored in the one or more data storage devices with the second value corresponding to the cookie received with the subsequent request, and determining, by the device, that the cookie is invalid based on the first value being different from the second value.

In another aspect, this disclosure is directed to a system. The system includes a device arranged intermediate a client and a server. The device may be configured to receive, from the client, a first request for the server. The device may be configured to transmit one or more data packets to the client. The one or more data packets may include a response to the request from the server and an attribute collector script configured to execute on the client to automatically transmit, to the device, one or more attributes corresponding to at least one of the client or a browser of the client. The device may be configured to receive, from the client, a second request including one or more attributes collected using the attribute collector script. The device may be configured to determine, using the one or more attributes, whether the client is associated with an autonomous program. The device may be configured to block, responsive to determining that the client is associated with an autonomous program, one or more subsequent requests from the client to the server.

In some embodiments, transmitting the one or more data packets including the attribute collector script is performed responsive to the first request not including a cookie from the client. In some embodiments, the device is further configured to transmit, responsive to determining that the client is not associated with an autonomous program, the one or more subsequent requests to the server. In some embodiments, the device is further configured to transmit the first request received from the client to the server. The device may be configured to receive, from the server, the response to the first request. The device may be configured to generate the one or more data packets using the response to the first request by inserting the response and the attribute collector script into the one or more data packets. In some embodiments, the response is a first response, and the device is further configured to receive, from the server in response to the client not being associated with an autonomous program, one or more responses to the one or more subsequent requests. The device may be configured to generate a cookie associated with a session between the client and the server. The device may be configured to transmit, to the client, the one or more responses and the cookie.

In some embodiments, the device is further configured to receive, from the client, the one or more subsequent requests for the server. The one or more subsequent requests may include the cookie. The device may be configured to validate, by the device, the cookie included the one or more subsequent requests for the server, prior to transmitting the one or more subsequent request to the server via the session. In some embodiments, the device is further configured to determine that the cookie included in a subsequent request is expired or invalid. Responsive to determining that the cookie included in the subsequent request is expired or invalid, the device may be configured to perform one of generating a new cookie for the client, blocking the subsequent request from being transmitted to the server, or transmitting the one or more subsequent requests responsive to a count of grace requests in which the cookie is expired or invalid is less than a threshold. In some embodiments, determining that the cookie is invalid includes storing, in one or more data storage devices, a first value associated with the cookie associated with the session, computing a second value corresponding to the cookie received with the subsequent request from the client, comparing the first value stored in the one or more data storage devices with the second value corresponding to the cookie received with the subsequent request, and determining that the cookie is invalid based on the first value being different from the second value.

In still another aspect, this disclosure is directed to a non-transitory computer readable medium storing program instructions for causing a device including one or more processors to receive, from a client, a first request for a server. The medium may further store instructions for causing the device to transmit one or more data packets to the client. The one or more data packets may include a response to the request from the server and an attribute collector script configured to execute on the client to automatically transmit to the device one or more attributes corresponding to at least one of the client or a browser of the client. The medium may further store instructions for causing the device to receive, from the client, a second request including one or more attributes collected using the attribute collector script. The medium may further store instructions for causing the device to determine, using the one or more attributes, whether the client is associated with an autonomous program. The medium may further store instructions for causing the device to block, responsive to determining that the client is associated with an autonomous program, one or more subsequent requests from the client to the server.

In some embodiments, the instructions further cause the one or more processors to transmit, responsive to determining that the client is not associated with an autonomous program, the one or more subsequent requests to the server.

### BRIEF DESCRIPTION OF THE DRAWING FIGURES

Objects, aspects, features, and advantages of embodiments disclosed herein will become more fully apparent from the following detailed description, the appended claims, and the accompanying drawing figures in which like reference numerals identify similar or identical elements. Reference numerals that are introduced in the specification in association with a drawing figure may be repeated in one or more subsequent figures without additional description in the specification in order to provide context for other features, and not every element may be labeled in every figure. The drawing figures are not necessarily to scale, emphasis instead being placed upon illustrating embodiments, principles and concepts. The drawings are not intended to limit the scope of the claims included herewith.

FIG. 1A is a block diagram of embodiments of a computing device;

FIG. 1B is a block diagram depicting a computing environment comprising client device in communication with cloud service providers;

FIG. 2 is a block diagram of a system for autonomous program management, in accordance with an illustrative embodiment;

FIG. 3 is a flow diagram of a method for autonomous program management, in accordance with an illustrative embodiment; and

FIG. 4 is a flow diagram showing one possible implementation of the method of FIG. 3 by the system of FIG. 2, in accordance with an illustrative embodiment.

The features and advantages of the present solution will become more apparent from the detailed description set forth below when taken in conjunction with the drawings, in which like reference characters identify corresponding elements throughout. In the drawings, like reference numbers generally indicate identical, functionally similar, and/or structurally similar elements.

### DETAILED DESCRIPTION

For purposes of reading the description of the various embodiments below, the following descriptions of the sections of the specification and their respective contents may be helpful:

Section A describes a computing environment which may be useful for practicing embodiments described herein; and

Section B describes embodiments of systems and methods for autonomous program management.

### A. Network and Computing Environment

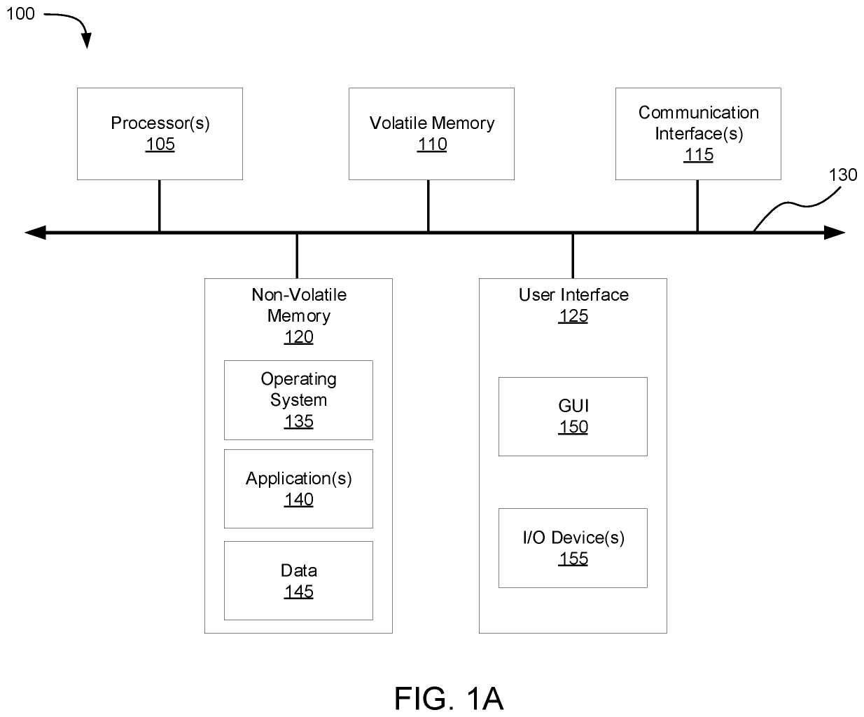

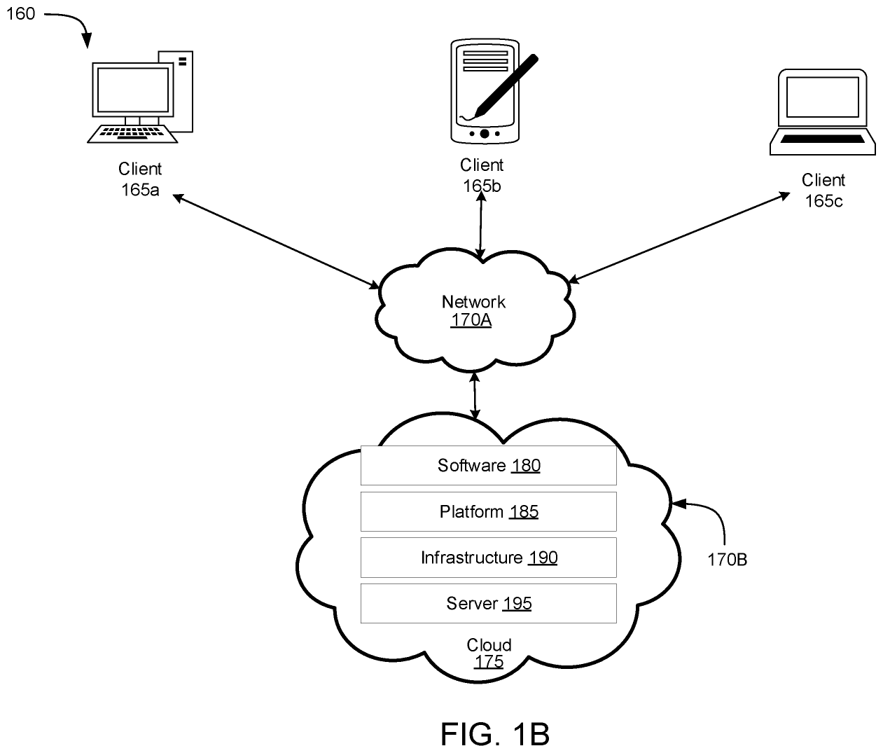

As shown in FIG. 1A, computer 100 may include one or more processors 105, volatile memory 110 (e.g., random access memory (RAM)), non-volatile memory 120 (e.g., one or more hard disk drives (HDDs) or other magnetic or optical storage media, one or more solid state drives (SSDs) such as a flash drive or other solid state storage media, one or more hybrid magnetic and solid state drives, and/or one or more virtual storage volumes, such as a cloud storage, or a combination of such physical storage volumes and virtual storage volumes or arrays thereof), user interface (UI) 125, one or more communications interfaces 115, and communication bus 130. User interface 125 may include graphical user interface (GUI) 150 (e.g., a touchscreen, a display, etc.) and one or more input/output (I/O) devices 155 (e.g., a mouse, a keyboard, a microphone, one or more speakers, one or more cameras, one or more biometric scanners, one or more environmental sensors, one or more accelerometers, etc.). Non-volatile memory 120 stores operating system 135, one or more applications 140, and data 145 such that, for example, computer instructions of operating system 135 and/or applications 140 are executed by processor(s) 105 out of volatile memory 110. In some embodiments, volatile memory 110 may include one or more types of RAM and/or a cache memory that may offer a faster response time than a main memory. Data may be entered using an input device of GUI 150 or received from I/O device(s) 155. Various elements of computer 100 may communicate via one or more communication buses, shown as communication bus 130.

Computer 100 as shown in FIG. 1A is shown merely as an example, as clients, servers, intermediary and other networking devices and may be implemented by any computing or processing environment and with any type of machine or set of machines that may have suitable hardware and/or software capable of operating as described herein. Processor(s) 105 may be implemented by one or more programmable processors to execute one or more executable instructions, such as a computer program, to perform the functions of the system. As used herein, the term “processor” describes circuitry that performs a function, an operation, or a sequence of operations. The function, operation, or sequence of operations may be hard coded into the circuitry or soft coded by way of instructions held in a memory device and executed by the circuitry. A “processor” may perform the function, operation, or sequence of operations using digital values and/or using analog signals. In some embodiments, the “processor” can be embodied in one or more application specific integrated circuits (ASICs), microprocessors, digital signal processors (DSPs), graphics processing units (GPUs), microcontrollers, field programmable gate arrays (FPGAs), programmable logic arrays (PLAs), multi-core processors, or general-purpose computers with associated memory. The “processor” may be analog, digital or mixed-signal. In some embodiments, the “processor” may be one or more physical processors or one or more “virtual” (e.g., remotely located or “cloud”) processors. A processor including multiple processor cores and/or multiple processors multiple processors may provide functionality for parallel, simultaneous execution of instructions or for parallel, simultaneous execution of one instruction on more than one piece of data.

Communications interfaces 115 may include one or more interfaces to enable computer 100 to access a computer network such as a Local Area Network (LAN), a Wide Area Network (WAN), a Personal Area Network (PAN), or the Internet through a variety of wired and/or wireless or cellular connections.

In described embodiments, the computing device 100 may execute an application on behalf of a user of a client computing device. For example, the computing device 100 may execute a virtual machine, which provides an execution session within which applications execute on behalf of a user or a client computing device, such as a hosted desktop session. The computing device 100 may also execute a terminal services session to provide a hosted desktop environment. The computing device 100 may provide access to a computing environment including one or more of: one or more applications, one or more desktop applications, and one or more desktop sessions in which one or more applications may execute.

Referring to FIG. 1B, a computing environment 160 is depicted. Computing environment 160 may generally be considered implemented as a cloud computing environment, an on-premises (“on-prem”) computing environment, or a hybrid computing environment including one or more on-prem computing environments and one or more cloud computing environments. When implemented as a cloud computing environment, also referred as a cloud environment, cloud computing or cloud network, computing environment 160 can provide the delivery of shared services (e.g., computer services) and shared resources (e.g., computer resources) to multiple users. For example, the computing environment 160 can include an environment or system for providing or delivering access to a plurality of shared services and resources to a plurality of users through the internet. The shared resources and services can include, but not limited to, networks, network bandwidth, servers 195, processing, memory, storage, applications, virtual machines, databases, software, hardware, analytics, and intelligence.

In embodiments, the computing environment 160 may provide client 165 with one or more resources provided by a network environment. The computing environment 165 may include one or more clients 165a-165n, in communication with a cloud 175 over one or more networks 170A, 170B. Clients 165 may include, e.g., thick clients, thin clients, and zero clients. The cloud 175 may include back end platforms, e.g., servers 195, storage, server farms or data centers. The clients 165 can be the same as or substantially similar to computer 100 of FIG. 1A.

The users or clients 165 can correspond to a single organization or multiple organizations. For example, the computing environment 160 can include a private cloud serving a single organization (e.g., enterprise cloud). The computing environment 160 can include a community cloud or public cloud serving multiple organizations. In embodiments, the computing environment 160 can include a hybrid cloud that is a combination of a public cloud and a private cloud. For example, the cloud 175 may be public, private, or hybrid. Public clouds 175 may include public servers 195 that are maintained by third parties to the clients 165 or the owners of the clients 165. The servers 195 may be located off-site in remote geographical locations as disclosed above or otherwise. Public clouds 175 may be connected to the servers 195 over a public network 170. Private clouds 175 may include private servers 195 that are physically maintained by clients 165 or owners of clients 165. Private clouds 175 may be connected to the servers 195 over a private network 170. Hybrid clouds 175 may include both the private and public networks 170A, 170B and servers 195.

The cloud 175 may include back end platforms, e.g., servers 195, storage, server farms or data centers. For example, the cloud 175 can include or correspond to a server 195 or system remote from one or more clients 165 to provide third party control over a pool of shared services and resources. The computing environment 160 can provide resource pooling to serve multiple users via clients 165 through a multi-tenant environment or multi-tenant model with different physical and virtual resources dynamically assigned and reassigned responsive to different demands within the respective environment. The multi-tenant environment can include a system or architecture that can provide a single instance of software, an application or a software application to serve multiple users. In embodiments, the computing environment 160 can provide on-demand self-service to unilaterally provision computing capabilities (e.g., server time, network storage) across a network for multiple clients 165. The computing environment 160 can provide an elasticity to dynamically scale out or scale in responsive to different demands from one or more clients 165. In some embodiments, the computing environment 160 can include or provide monitoring services to monitor, control and/or generate reports corresponding to the provided shared services and resources.

In some embodiments, the computing environment 160 can include and provide different types of cloud computing services. For example, the computing environment 160 can include Infrastructure as a service (IaaS). The computing environment 160 can include Platform as a service (PaaS). The computing environment 160 can include server-less computing. The computing environment 160 can include Software as a service (SaaS). For example, the cloud 175 may also include a cloud based delivery, e.g. Software as a Service (SaaS) 180, Platform as a Service (PaaS) 185, and Infrastructure as a Service (IaaS) 190. IaaS may refer to a user renting the use of infrastructure resources that are needed during a specified time period. IaaS providers may offer storage, networking, servers or virtualization resources from large pools, allowing the users to quickly scale up by accessing more resources as needed. Examples of IaaS include AMAZON WEB SERVICES provided by Amazon.com, Inc., of Seattle, Wash., RACKSPACE CLOUD provided by Rackspace US, Inc., of San Antonio, Tex., Google Compute Engine provided by Google Inc. of Mountain View, Calif., or RIGHTSCALE provided by RightScale, Inc., of Santa Barbara, Calif. PaaS providers may offer functionality provided by IaaS, including, e.g., storage, networking, servers or virtualization, as well as additional resources such as, e.g., the operating system, middleware, or runtime resources. Examples of PaaS include WINDOWS AZURE provided by Microsoft Corporation of Redmond, Wash., Google App Engine provided by Google Inc., and HEROKU provided by Heroku, Inc. of San Francisco, Calif. SaaS providers may offer the resources that PaaS provides, including storage, networking, servers, virtualization, operating system, middleware, or runtime resources. In some embodiments, SaaS providers may offer additional resources including, e.g., data and application resources. Examples of SaaS include GOOGLE APPS provided by Google Inc., SALESFORCE provided by Salesforce.com Inc. of San Francisco, Calif., or OFFICE 365 provided by Microsoft Corporation. Examples of SaaS may also include data storage providers, e.g. DROPBOX provided by Dropbox, Inc. of San Francisco, Calif., Microsoft SKYDRIVE provided by Microsoft Corporation, Google Drive provided by Google Inc., or Apple ICLOUD provided by Apple Inc. of Cupertino, Calif.

Clients 165 may access IaaS resources with one or more IaaS standards, including, e.g., Amazon Elastic Compute Cloud (EC2), Open Cloud Computing Interface (OCCI), Cloud Infrastructure Management Interface (CIMI), or OpenStack standards. Some IaaS standards may allow clients access to resources over HTTP, and may use Representational State Transfer (REST) protocol or Simple Object Access Protocol (SOAP). Clients 165 may access PaaS resources with different PaaS interfaces. Some PaaS interfaces use HTTP packages, standard Java APIs, JavaMail API, Java Data Objects (JDO), Java Persistence API (JPA), Python APIs, web integration APIs for different programming languages including, e.g., Rack for Ruby, WSGI for Python, or PSGI for Perl, or other APIs that may be built on REST, HTTP, XML, or other protocols. Clients 165 may access SaaS resources through the use of web-based user interfaces, provided by a web browser (e.g. GOOGLE CHROME, Microsoft INTERNET EXPLORER, or Mozilla Firefox provided by Mozilla Foundation of Mountain View, Calif.). Clients 165 may also access SaaS resources through smartphone or tablet applications, including, e.g., Salesforce Sales Cloud, or Google Drive app. Clients 165 may also access SaaS resources through the client operating system, including, e.g., Windows file system for DROPBOX.

In some embodiments, access to IaaS, PaaS, or SaaS resources may be authenticated. For example, a server or authentication server may authenticate a user via security certificates, HTTPS, or API keys. API keys may include various encryption standards such as, e.g., Advanced Encryption Standard (AES). Data resources may be sent over Transport Layer Security (TLS) or Secure Sockets Layer (SSL).

### B. Systems and Methods for Autonomous Program Management

The present disclosure is directed towards systems and methods for bot (or autonomous program) management. In some aspects, the present disclosure is directed towards a device (and corresponding method) for client fingerprinting in distributed systems in real-time.

Bots or autonomous programs (e.g., web robots) are prevalent in today's network traffic. Bots can imitate or replace human user behavior and perform tasks on a faster pace than a human user of a client device. However, the traffic from bots can overwhelm and/or slow down a networks resources resulting in disrupted or delayed service to human users of one or more client devices. The bots can include malicious or attack bots programmed to break into accounts, steal information and/or perform malicious activities. Thus, it is increasingly important to detect and differentiate traffic and/or connections from bots versus a human user.

According to the embodiments described herein, a device may employ, use, or leverage a client “fingerprinting technique” to determine whether a connection is from an autonomous program or a human being. In some embodiments, the device may perform fingerprinting by inserting an attribute collection script (or JavaScript snippet) into an HTML Response served to a client. The attribute collection script, when invoked by a browser on the client, collects attributes of the browser and client and sends those attributes in an HTTP POST request to the device. The device may analyze the attributes to whether the connection appears to be from an autonomous program or a human being. Also, even the lack of this request points out that the connection may be from a Bot.

When the connection is determined to be from a human being, the device generates a unique identifier (e.g., a unique fingerprint identifier or cookie) corresponding to the client. The device may generate the unique identifier including various encrypted information corresponding to the session, and transmits the cookie with a subsequent response and a set-cookie HTTP header. The unique identifier may be unique for that client and the session, including the browser used. The device may compute a cookie. In some embodiments, the device may generate a cookie by computing a hash (e.g., an SHA 1 hash) using various attributes, such as browser plugins, browser fonts, UserAgent, browser CanvasPrint, screen resolution, color depth, and CPU. The cookie may thus contain information or data which can help the device identify a session and client, including the unique identifier for the client. The cookie may include cookie data appended by a cookie sign (e.g., <cookie data><cookie sign>). The cookie sign is generated by computing a hash-based message authentication code (HMAC) on the cookie data with a key shared between all of the nodes (e.g., HMAC(<cookie data>, Key)). The cookie may be versioned so that, for a specific version, a length of the cookie data and an offset of the cookie sign is known.

For subsequent requests from the client, the device may validate the cookie to verify that the cookie is valid for the particular client, no tampering has occurred due to an autonomous program, and that the cookie is received as expected from a human being normally using a browser. The cookie may contain information which can help the device identify the session and the client, including the uniquely generated fingerprint ID. The device may validate the cookie to determine if any tampering has occurred. Where the cookie has been tampered with, modified, or otherwise altered, or if the device does not receive a cookie following a predetermined amount of grace requests, the device may determine that the connection is from an autonomous program.

The device may validate a cookie by first validating that determined length of the cookie from the client has a length which corresponds to the particular version. The device may then determine the cookie sign by computing the HMAC on the cookie data. The device may compare the computed cookie sign to the one received from the client. If the cookie signs match, the device may determine that the cookie is valid and has not been tampered with. If the cookie has been tampered with (or if no cookie has been received after a predetermined amount of grace requests), the device may determine that the connection is from an autonomous program. In some embodiments, where the cookie is tampered with or expired, the device may challenge the client again with the device fingerprinting technique as described above, to ensure that the client is still associated with a human rather than an autonomous program. According to the systems and methods described herein, the autonomous program management may provide for bot functionality across a network or cluster of devices in real-time.

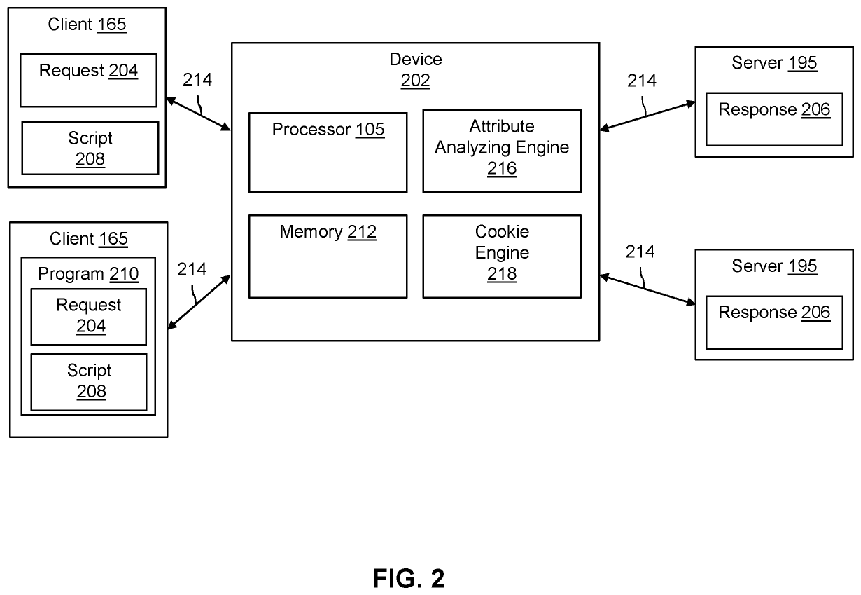

Referring now to FIG. 2, depicted is a system 200 for autonomous program management, according to an illustrative embodiment. The system 200 may include an intermediary device 202, intermediary to a plurality of clients 165 and a plurality of servers 195. The device 202 can handle or process one or more requests 204 from one or more clients 165 to one or more servers 195. The device 210 can handle or process one or more responses 206 from one or more servers 195 to one or more clients 165. The device 202 can transmit a script 208 to each of the clients 165 with a response 222 to a request 204. The script 208 may transmit browser and/or client attributes collected by the script 208. The device 202 may analyze the attributes collected by the script 208 to determine whether the client 165 is associated with an autonomous program 210.

The device 202 can be implemented using hardware or a combination of software and hardware. For example, each component of the device 202 can include logical circuitry (e.g., a central processing unit or CPU) that responses to and processes instructions fetched from a memory unit (e.g., memory 212). Each component of the device 202 can include or use a microprocessor 105 or a multi-core processor 105. A multi-core processor 105 can include two or more processing units on a single computing component. Each component of the device 202 can be based on any of these processors, or any other processor capable of operating as described herein. Each processor 105 can utilize instruction level parallelism, thread level parallelism, different levels of cache, etc. For example, the device 202 can include at least one logic device such as a computing device or server having at least one processor 105 to communicate via a network 170. The components and elements of the device 202 can be separate components or a single component. For example, the device 202 can include combinations of hardware and software, such as one or more processors 105 configured to initiate stop commands, initiate motion commands, and transmit or receive event data, for example.

The device 202 can include a memory component (e.g., memory 212) to store and retrieve data. The memory 212 can include a random access memory (RAM) or other dynamic storage device, coupled with the device 202 for storing information, and instructions to be executed by the device 202. The memory 212 can include at least one read only memory (ROM) or other static storage device coupled with the device 202 for storing static information and instructions for the device 202. The memory 212 can include a storage device, such as a solid state device, magnetic disk or optical disk, coupled with the device 202 to persistently store information and instructions.

Clients 165 can include any form of a computing device described herein. The clients 165 can generate a request 204 for at least one server 195 or for an application or resource provided by at least one server 195. The request 204 can identify or indicate the server 195 and/or the application. The request 204 can identify or indicate the client 165 transmitting the request 204. The client 165 can transmit or provide the request 204 to the device 202 through at least one connection 214. For example, the clients 165 can connect with the device 202 and/or one or more servers 195 through one or more connections 214. The client 165 can establish a connection 214 to the device 202 to access or request access to at least one server 195 or an application provided by a server 195.

The connections 214 can include a channel, connection or session between a client 165 and the device 202, between the device 202 and a server 195 and/or between a client 165 and a server 195. In some embodiments, the connections 214 can include encrypted and/or secure connections 214. For example, the connections 214 may include encrypted sessions and/or secure sessions. The encrypted connections 214 can include encrypted files, data and/or traffic transmitted between a client 165 and the device 202, between the device 202 and a server 195 and/or between a client 165 and a server 195.

In some embodiments, a client 165 can include or execute an autonomous program 210. In embodiments, an autonomous program 210 can imitate a client 165 can initiate a connection or attempt to connect to the device 101. The autonomous program 210 can include or correspond to a bot or web robot configured to behave like a human user of a client 165. For example, the autonomous program 210 can imitate or replace human user behavior and perform tasks, such as but not limited to, interacting with or following a link provided within a response 206 or a web page. In embodiments, the autonomous program 210 provide one or more requests 204 to the device 210. For example, the autonomous program 206 can generate a request 204 for the server 195 and forward the request 204 to the device 210.

Servers 195 can include or deployed as, and/or be executed on any type and form of computing device, such as any desktop computer, laptop computer, or mobile device capable of communication over at least one network and performing the operations described herein. For example, servers 195 can include or correspond to one computer, a plurality of computers, or a network of distributed computers such as computer 100 shown in FIG. 1A. In embodiments, servers 195 can executes one or more applications on behalf of one or more of clients 165 (e.g., as an application server), although other uses are possible, such as a file server, gateway server, proxy server, or other similar server uses. Clients 165 may seek access to hosted applications on servers 106. The applications may include network applications that are served from and/or hosted on one or more servers (e.g., server 195, remote servers, application servers). The applications can include an application hosted on at least one server 195 and accessed by at least one client 165 via a network 170. The applications can include, but not limited to, a web application, a desktop application, remote-hosted application, a virtual application, a software as a service (SaaS) application, a mobile application, an HDX application, a local application, a native application (e.g., native to the client device), and/or a device couple with one or more of the clients 165.

Each of the above-mentioned elements or entities is implemented in hardware, or a combination of hardware and software, in one or more embodiments. Each component of the device 210 may be implemented using hardware or a combination of hardware or software detailed above in connection with FIGS. 1A-1B. For instance, each of these elements or entities can include any application, program, library, script, task, service, process or any type and form of executable instructions executing on hardware of a client device (e.g., device 202). The hardware includes circuitry such as one or more processors 105 in one or more embodiments.

The device 202 may be configured to transmit responses 206 from the server 195 to the client 165. The device 202 may be configured to include, embed, incorporate, or otherwise provide an attribute collector script 208 (also referred to as a script 208) into the response 206 sent to the client 165. The attribute collector script 208 may be an executable software or script designed or implemented to automatically collect one or more attributes of the client 165 and/or browser of the client 165. In some embodiments, the attribute collector script 208 may be a JavaScript snippet configured to execute on the client 165 and collect attribute(s) of the client 165 and/or browser. In some embodiments, the attribute collector script 208 may be configured to automatically collect and transmit the attribute(s) to the device 202 responsive to the client receiving the script 208 from the device 202. In other words, the attribute collector script 208 may be a self-executing script which runs on the client 165 and collects one or more attributes corresponding to the client 165 and/or browser. Various examples of attributes may include, for instance, attributes corresponding to the browser such as a user-agent, browser name (e.g., Internet Explorer, GOOGLE Chrome, FIREFOX, SAFARI, OPERA, etc.), a browser version, a browser major version etc., attributes corresponding to the device, such as operating system (e.g., WINDOWS, MAC, LINUX, UBUNTU, SOLARIS), a device model, a device vendor, a device type, a central processing unit (CPU) architecture, whether the device is a mobile device and attributes corresponding thereto (e.g., mobile version, mobile OS [such as ANDROID, OPERA mini, IEMobile, BLACKBERRY, IPHONE, IPAD, IPOD]), screen attributes (e.g., current screen resolution, available screen resolution, color depth, device XDPI, device YDPI), whether the device has any plugins enabled and corresponding versions (e.g., JAVA, Flash, SILVERLIGHT, etc.), mime types, fonts (such as current or available fonts), local storage availability, whether cookies are enabled, a current time zone, a language, a system language, a canvas, etc.

The attribute collector script 208 may be configured to automatically transmit the one or more attributes. In some embodiments, the attribute collector script 208 may be configured to transmit the one or more attributes with a subsequent request 204, or separate from a subsequent request 204. In some embodiments, the subsequent request 204 may be a POST request which includes the one or more attributes in the POST body. The device 202 may include an attribute analyzing engine 216. The attribute analyzing engine 216 may be any device(s), component(s), script, or other combination of hardware and/or software designed or implemented to analyze attributes collected by the script 208 and received from the client 165. The attribute analyzing engine 216 may be configured to parse, inspect, or otherwise analyze the attribute(s) collected by the script 208 to determine whether the client 165 is associated with an autonomous program 210. For example, various attributes may be indicative of a client 165 being associated with an autonomous program 210. In some embodiments, the attribute analyzing engine 216 may include, maintain, or otherwise access a database or data structure. The attribute analyzing engine 216 may be configured to analyze the attributes to determine whether one or more of the attributes are indicative of the client 165 being associated with an autonomous program 210.

As one example, the device 202 may receive an attribute corresponding to a display of the client 165. The attribute may indicate that the client 165 does not include, or is not currently using, a display (e.g., the client 165 is executing requests 204 without displaying any information or data). The attribute analyzing engine 216 may be configured to parse each of the attributes received via the script 208 from the client 165 (including the attribute corresponding to the display) to determine whether the client 165 is associated an autonomous program 210. For example, the attribute analyzing engine 216 may be configured to determine that the client 165 is associated with an autonomous program 210 since the client 165 has an attribute indicating that the client 165 does not include (or is not using) a display.

As another example, the device 202 may receive an attribute indicating the plugins are disabled for the browser of the client 165. The attribute analyzing engine 216 may be configured to parse each of the attributes received via the script 208 from the client 165 (including the attribute corresponding to the plugins) to determine whether the client 165 is associated an autonomous program 210. For example, the attribute analyzing engine 216 may be configured to determine that the client 165 is associated with an autonomous program 210 since the client 165 has plugins disabled.

As yet another example, the device 202 may receive an attribute corresponding to an operating system of the client 165 which indicates the client 165 is executing an old or out-of-date operating system. The attribute analyzing engine 216 may be configured to parse each of the attributes received via the script 208 from the client 165 (including the attribute corresponding to the operating system) to determine whether the client 165 is associated an autonomous program 210. For example, the attribute analyzing engine 216 may be configured to determine that the client 165 is associated with an autonomous program 210 since the client 165 is operating, executing, or otherwise using an operating system which is old or out-of-date.

According to these and other embodiments, the device 202 may be configured to parse, inspect, or otherwise analyze attributes received via the script 208 from the client 165 to determine whether the client 165 is executing, running, or otherwise operating an autonomous program 210. The device 202 may be configured to compare the attributes received via the script 208 to predetermined attributes which are associated with an autonomous program 210. In some embodiments, the device 202 may be configured to compare each of the attributes to predetermined attributes to determine whether it is more likely than not that the client 165 is associated with an autonomous program 165. For example, the device 202 may be configured to compute a probability in which the client 165 is associated with an autonomous program 165. As more attributes from the client 165 match predetermined attributes stored in memory 212 of the device 202, the attribute analyzing engine 216 may be configured to increase the probability that the client 165 is associated with an autonomous program 210.

Where the device 202 determines that the client 165 is associated with an autonomous program 210, the device 202 may be configured to block one or more subsequent requests 204 from being passed, transmitted, or otherwise provided to the backend server 195. However, where the device 202 determines that the client 165 is associated with a human operator, the device 202 may be configured to generate a cookie for the client 165. In some embodiments, the device 202 may be configured to generate the cookie using one or more of the attributes corresponding to the client 165. As such, the cookie may be unique to a particular client 165. In some embodiments, the cookie engine 218 may be configured to generate the cookie for the client 165. As described in greater detail below, the client 165 may transmit subsequent requests 204 for a server 195. The client 165 may transmit the cookie with those subsequent requests 204. The cookie engine 218 may be configured to validate the cookie received from the client 165 to determine whether the cookie is associated with the client 165, and whether the cookie has been tampered. Where the cookie is associated with the client 165 and has not been tampered with, the device 202 may transmit the request 204 from the client 165 to the server 195, and transmit a corresponding response 206 from the server 195 to the client 165.

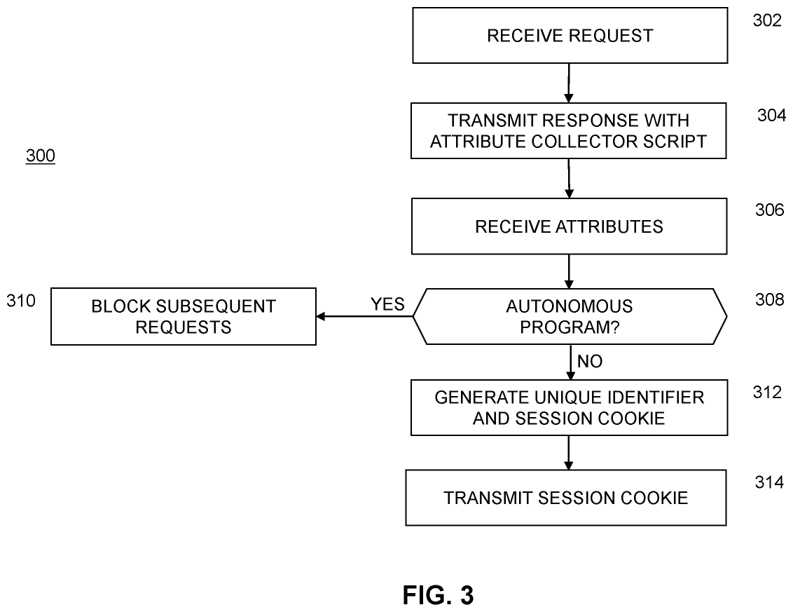

Referring now to FIG. 3, depicted is a flow diagram of one embodiment of a method 300 for autonomous program management, according to an illustrative embodiment. Any of the operations described herein may be performed by any one or more of the components or devices described above, for example, the device 202 or processor 105 (e.g., using instructions from memory 212). As a brief overview of the method 300, at step 302, a device may receive a request. At step 304, the device may transmit a response with an attribute collector script. At step 306, the device may receive attributes. At step 308, the device may determine whether the client is associated with an autonomous program. Where the attributes are determined to be associated with an autonomous program, the method 300 may proceed to step 310, where the device blocks subsequent requests. However, where the attributes are determined to be associated with a human operator, the method 300 may proceed to step 312, where the device generates a unique identifier and session cookie. At step 314, the device may transmit the session cookie.

At step 302, a device may receive a request. In some embodiments, a device intermediary to a client and server may receive a first request for the server from the client. In some embodiments, the first request may be an HTTP request (such as an HTTP GET request) to retrieve data from a backend server. The client may establish a connection or session with the device and transmit the HTTP request to the device. The device may transmit the request to the backend server. The backend server may process the request and generate a corresponding response for the client. The server may transmit the response to the device, which may then transmit the response to the client, as described in greater detail below.

At step 304, the device may transmit a response with an attribute collector script. In some embodiments, the device may transmit one or more data packets to the client. The data packet(s) may include a response to the request received at step 302. The packet(s) may include an attribute collector script which executes on the client to automatically transmit one or more attributes corresponding to the client and/or a browser of the client to the device. In some embodiments, the device may include, embed, or otherwise incorporate the attribute collector script into the response received from the server. In some embodiments, the device may transmit the attribute collector script in a packet which is separate from the packet containing the response from the backend server. The attributes may include at least some of those attributes described above, such as attributes corresponding to the browser, screen, operating system, etc. In some embodiments, the device may transmit the data packet(s) including the attribute collector script when the request (e.g., received at step 302) does not include a cookie corresponding to an existing session between the client and device. As described in greater detail below, the device may generate a cookie responsive to the device determining that the client is not associated with an autonomous program (e.g., a bot).

At step 306, the device may receive attributes. In some embodiments, the device may receive a second request from the client which include one or more attributes collected using the attribute collector script. Hence, the attribute collector script may automatically execute on the client to collect and transmit the attributes of the browser/client to the device. In some embodiments, the attribute collector script may transmit the attributes responsive to being invoked by the browser of the client. In some embodiments, the second request may be an HTTP request (such as an HTTP POST request). In other words, the device may receive an HTTP POST request including the attributes from the client retrieved or collected via the script. Hence, the attribute collector script may cause the attribute(s) to be transmitted to the device via the HTTP POST request. The HTTP POST request may be a dedicated HTTP POST request which includes the attributes corresponding to the client and/or browser. In some embodiments, the device may receive the attributes from the client with another request from the client (e.g., the attributes may be included or incorporated in an HTTP request generated by the client). In some embodiments, the device may receive one or more additional requests between transmitting the response (e.g., at step 304) and receiving the attributes (at step 306). The device may route those requests to the corresponding server, and transmit the response from the server to the client.

At step 308, the device may determine whether the client is associated with an autonomous program. In some embodiments, the device may determine whether the client is associated with an autonomous program using the attributes (e.g., received at step 306). In some embodiments, the device may determine whether the client is associated with an autonomous program based on a comparison of the attribute(s) to various available attributes and settings stored in memory of the device (or otherwise accessible by the device). For example, some attributes may indicate that the client is more than likely associated with an autonomous program (such as attributes corresponding to various screen or display settings, attributes corresponding to an operating system of the client, etc.). In some embodiments, the device may calculate or compute a probability that the client is associated with an autonomous program. The device may compute the probability based on an amount of attributes of the client that correspond to a client which is more than likely associated with an autonomous program. As the number of attributes that correspond to a client which is more than likely associated with an autonomous program increases, the probability may correspondingly increase.

Where the attributes are determined to be associated with an autonomous program, the method 300 may proceed to step 310, where the device blocks subsequent requests. In some embodiments, the device may block one or more subsequent requests from the client to the server responsive to determining that the client is associated with an autonomous program. In some embodiments, the device may block the requests by not delivering the request to the server, not returning a response from the server to the client, transmitting a “blocked” or “error” message to the client, and so forth. Accordingly, the device may block requests which are transmitted from clients that are determined to be associated with autonomous programs. In some embodiments, the device may block the requests from the client for a predetermined duration (e.g., for a number of minutes, hours, days, etc.) until the device performs client “fingerprinting” by collecting the attributes from the client via the attribute collector script. In some embodiments, the device may block the requests from the client indefinitely.

Where the attributes are determined to be associated with a human operator, the method 300 may proceed to step 312. At step 312, the device generates a unique identifier and session cookie. In some embodiments, the device may compute, determine, or otherwise generate a unique identifier corresponding to the client. In some embodiments, the unique identifier may be, in some respects, a “digital fingerprint” which is unique to the client. The device may generate the unique identifier using the attribute(s) from the client. For example, the device may generate the unique identifier by computing a hash (such as an SHA 1 hash) using various attributes from the client, such as browser plugins, browser fonts, UserAgent, browser CanvasPrint, screen resolution, color depth, and/or CPU (among other possible attributes).

In some embodiments, responsive to generating the unique identifier, the device may generate a cookie (or other data object) which is used for identifying the session between the client and server. Hence, the cookie may be associated with or otherwise correspond to the session between the client and the server. The cookie may contain information which the device uses for identifying the session between the client and server. In some embodiments, the cookie may contain the unique identifier generated based on the attribute(s). In some embodiments, the cookie may include cookie data (which may include the unique identifier) and a cookie sign. The device may compute the cookie sign by computing a hash-based message authentication code (HMAC) on the cookie data with a shared key. The cookie may be versioned so that each version of a cookie has a known length of cookie data and offset of a cookie sign. As described in greater detail below, the device may use the cookie for verifying that the cookie corresponds to the particular client and has not been tampered with.

At step 314, the device may transmit the session cookie. In some embodiments, the device may transmit the session cookie to the client, to set the cookie for the browser of the client. In some embodiments, the device may transmit the cookie with a response to a subsequent request (e.g., received from the client for a server). In some embodiments, the device may transmit the cookie with a response to the HTTP POST request that included to the attributes (e.g., received at step 306). In other words, the device may transmit the cookie with a response to the attributes received in the HTTP POST request from the client.

In some embodiments, the device may receive additional or subsequent requests responsive to transmitting the cookie to the client (and the client setting the cookie for the browser). The subsequent requests may be for the backend server (or for a different server). The client may transmit the subsequent requests with the cookie received from the device. Hence, the device may receive subsequent requests from the client that include the cookie. The device may validate the cookie which was included in the subsequent requests. In some embodiments, the device may validate the cookie prior to transmitting the subsequent request to the server via the session. In some embodiments, the device may validate the cookie by determining a version associated with the cookie and comparing a length of the cookie with a predetermined length which is associated with the version of the cookie. Where the length of the cookie from the client matches the predetermined length associated with the version of the cookie, the device may determine that that the cookie may be a valid cookie. The device may then determine the cookie sign for the cookie by computing the HMAC on the cookie data. The device may compare the computed cookie sign with the cookie sign received in the cookie with the subsequent request. Where the cookie signs match, the device may validate the cookie (since the cookie has not been tampered with). However, where the cookie signs do not match, the device may treat the cookie as being expired, invalid, or otherwise tampered with.

In some embodiments, where the device determines that the cookie is expired or invalid, the device may generate a new cookie for the client (e.g., by repeating steps 304-312). In some embodiments, where the device determines that the cookie is expired or invalid, the device may block the subsequent requests from being transmitted to the server. In other words, where a cookie is expired or invalid, the device may treat the client as being associated with an autonomous program. In some embodiments, the device may treat the client as being associated with an autonomous program responsive to the client generating a predetermined number of requests with an invalid or expired cookie. Hence, the device may provide the client with a predetermined number of grace requests prior to treating the client as being associated with an autonomous program. In some embodiments, the number of grace requests can be 1, 2, 3, 4, 5 or more than 5. Where the number of subsequent requests transmitted by the client to the device is less than the predetermined number of grace requests, the device may transmit the subsequent requests to the server and provide the corresponding responses from the server to the client. However, once the number of subsequent requests from the client exceeds the predetermined number of grace requests, the device may treat the client as being associated with an autonomous program, and the device may block further requests from the client.

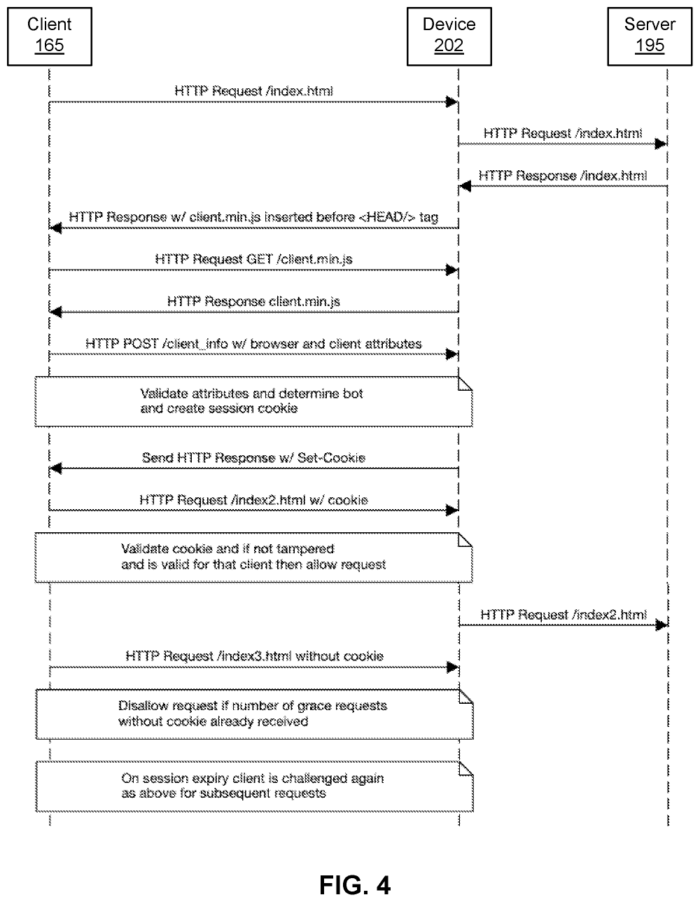

Referring now to FIG. 4, depicted is one possible implementation of the method 300 of FIG. 3 performed by the components of the system 200 shown in FIG. 2, according to an illustrative embodiment. As shown in FIG. 4, the client 165 sends an HTTP request (such as an HTTP GET request) to the device 202 for transmitting to the server (e.g., a backend or origin server). The device 202 may transmit the HTTP request to the server 195 according to the request from the client 165. The server 195 may transmit an HTTP response to the device 202 for transmitting back to the client 165.

Once the device 202 receives the response from the server 195, the device 202 may modify the response received from the server 195 by inserting the attribute collector script (e.g., a JavaScript snippet) in the response from the server 195. In some embodiments, the device 202 may insert the attribute collector script before the header. The attribute collector script may automatically execute on the browser of the client 165 and transmit attributes corresponding to the browser and/or client back to the device 202. In some embodiments, the attribute collector script may execute on the browser of the client 165 when the client 165 invokes the attribute collector script (e.g., by transmitting another HTTP request to the device 202 for the server 195). Once the attribute collector script is invoked and executes, the attribute collector script may automatically collect and transmit one or more attributes corresponding to the client 165 to the device 202. In some embodiments, the attribute collector script may cause the attribute(s) to be transmitted from the client 165 to the device 202 via an HTTP POST request (e.g., the attributes may be included in a body of the HTTP POST request).

When the device 202 receives the attributes from the client 165, the device 202 may validate the attributes and determine whether the client 165 is associated with an autonomous program (e.g., based on the attributes from the client 165 collected via the attribute collector script). Where the device 202 determines the client 165 is associated with an autonomous program, the device 202 may block subsequent requests from being transmitted via the device 202 to the server 195. However, where the device 202 determines the client 165 is associated with a human operator, the device 202 may generate or create a unique session cookie corresponding to the session between the client 165 and server 195. The device 202 may transmit the session cookie to the client 165 with an HTTP response (e.g., to the subsequent HTTP request) with a set cookie instruction. The browser of the client 165 may correspondingly set the session cookie from the device 202 as a cookie for the browser.

When the client 165 generates and transmits further subsequent requests to the device 202, the client 165 may include the session cookie corresponding to the session between the client 165 and server 195. The device 202 may validate whether the subsequent request from the client 165 contain the corresponding session cookie, and whether the cookie was tampered with to determine that the connection is still from a human operator (as opposed to an autonomous program). In some embodiments, such as where the client 165 does not include the cookie with a subsequent request, the device 202 may provide a number of grace requests. Hence, the device 202 may allow permit, or otherwise provide a number of grace requests from the client 165 to the server 195 without the session cookie. However, once subsequent requests from the client 165 which do not include the session cookie exceeds the number of grace requests, the device 202 may re-challenge the client 165 (e.g., as described above) to verify that the client is associated with a human rather than an autonomous program.

Various elements, which are described herein in the context of one or more embodiments, may be provided separately or in any suitable subcombination. For example, the processes described herein may be implemented in hardware, software, or a combination thereof. Further, the processes described herein are not limited to the specific embodiments described. For example, the processes described herein are not limited to the specific processing order described herein and, rather, process blocks may be re-ordered, combined, removed, or performed in parallel or in serial, as necessary, to achieve the results set forth herein.

It will be further understood that various changes in the details, materials, and arrangements of the parts that have been described and illustrated herein may be made by those skilled in the art without departing from the scope of the following claims.

We claim:

1. A method comprising:
receiving, by a device intermediary to a client and a server, from the client, a first request for the server;
transmitting, by the device, one or more data packets to the client, the one or more data packets including a response to the request from the server and an attribute collector script configured to execute on the client to automatically transmit, to the device, one or more attributes corresponding to at least one of the client or a browser of the client;
receiving, by the device, from the client, a second request including one or more attributes collected using the attribute collector script;
determining, by the device, using the one or more attributes, whether the client is associated with an autonomous program; and
blocking, by the device, responsive to determining that the client is associated with an autonomous program, one or more subsequent requests from the client to the server.

2. The method of claim 1, wherein transmitting the one or more data packets including the attribute collector script is performed responsive to the first request not including a cookie from the client.

3. The method of claim 1, further comprising transmitting, by the device, responsive to determining that the client is not associated with an autonomous program, the one or more subsequent requests to the server.

4. The method of claim 1, further comprising:
transmitting, by the device, the first request received from the client to the server;
receiving, by the device, from the server, the response to the first request; and
generating, by the device, the one or more data packets using the response to the first request by inserting the response and the attribute collector script into the one or more data packets.

5. The method of claim 1, wherein the response is a first response, the method further comprising:
receiving, by the device from the server in response to the client not being associated with an autonomous program, a second response to the second request;
generating, by the device, a cookie associated with a session between the client and the server; and
transmitting, by the device, to the client, the second response and the cookie.

6. The method of claim 5, further comprising:
receiving, by the device from the client, one or more subsequent requests for the server, the one or more subsequent requests including the cookie; and
validating, by the device, the cookie included the one or more subsequent requests for the server, prior to transmitting the one or more subsequent request to the server via the session.

7. The method of claim 5, further comprising determining, by the device, that the cookie included in a subsequent request is expired or invalid.

8. The method of claim 7, further comprising, responsive to determining that the cookie included in the subsequent request is expired or invalid, performing one of:
generating, by the device, a new cookie for the client; or
blocking the subsequent request from being transmitted to the server responsive to the cookie being expired or invalid.

9. The method of claim 7, further comprising transmitting, by the device, the one or more subsequent requests responsive to a count of grace requests in which the cookie is expired or invalid is less than a threshold.

10. The method of claim 7, wherein determining that the cookie is invalid comprises:
storing, by the device, in one or more data storage devices, a first value associated with the cookie associated with the session;
computing, by the device, a second value corresponding to the cookie received with the subsequent request from the client;
comparing, by the device, the first value stored in the one or more data storage devices with the second value corresponding to the cookie received with the subsequent request; and
determining, by the device, that the cookie is invalid based on the first value being different from the second value.

11. A system comprising:
a device arranged intermediate a client and a server, the device configured to:
receive, from the client, a first request for the server;
transmit one or more data packets to the client, the one or more data packets including a response to the request from the server and an attribute collector script configured to execute on the client to automatically transmit, to the device, one or more attributes corresponding to at least one of the client or a browser of the client;
receive, from the client, a second request including one or more attributes collected using the attribute collector script;
determine, using the one or more attributes, whether the client is associated with an autonomous program; and
block, responsive to determining that the client is associated with an autonomous program, one or more subsequent requests from the client to the server.

12. The system of claim 11, wherein transmitting the one or more data packets including the attribute collector script is performed responsive to the first request not including a cookie from the client.

13. The system of claim 11, wherein the device is further configured to transmit, responsive to determining that the client is not associated with an autonomous program, the one or more subsequent requests to the server.

14. The system of claim 11, wherein the device is further configured to:
transmit the first request received from the client to the server;
receive, from the server, the response to the first request; and
generate the one or more data packets using the response to the first request by inserting the response and the attribute collector script into the one or more data packets.

15. The system of claim 11, wherein the response is a first response, and wherein the device is further configured to:
receive, from the server in response to the client not being associated with an autonomous program, one or more responses to the one or more subsequent requests;
generate a cookie associated with a session between the client and the server; and
transmit, to the client, the one or more responses and the cookie.

16. The system of claim 15, wherein the device is further configured to:
receive, from the client, the one or more subsequent requests for the server, the one or more subsequent requests including the cookie; and
validate, by the device, the cookie included the one or more subsequent requests for the server, prior to transmitting the one or more subsequent request to the server via the session.

17. The system of claim 15, wherein the device is further configured to:
determine that the cookie included in a subsequent request is expired or invalid; and responsive to determining that the cookie included in the subsequent request is expired or invalid, perform one of:
generate a new cookie for the client;
block the subsequent request from being transmitted to the server; or
transmit the one or more subsequent requests responsive to a count of grace requests in which the cookie is expired or invalid is less than a threshold.

18. The system of claim 17, wherein determining that the cookie is invalid comprises:
store, in one or more data storage devices, a first value associated with the cookie associated with the session;
compute a second value corresponding to the cookie received with the subsequent request from the client;
compare the first value stored in the one or more data storage devices with the second value corresponding to the cookie received with the subsequent request; and
determine that the cookie is invalid based on the first value being different from the second value.

19. A non-transitory computer readable medium storing program instructions for causing a device including one or more processors to:
receive, from a client, a first request for a server;
transmit one or more data packets to the client, the one or more data packets including a response to the request from the server and an attribute collector script configured to execute on the client to automatically transmit to the device one or more attributes corresponding to at least one of the client or a browser of the client;
receive, from the client, a second request including one or more attributes collected using the attribute collector script;
determine, using the one or more attributes, whether the client is associated with an autonomous program; and
block, responsive to determining that the client is associated with an autonomous program, one or more subsequent requests from the client to the server.

20. The non-transitory computer readable medium of claim 19, wherein the instructions further cause the one or more processors to transmit, responsive to determining that the client is not associated with an autonomous program, the one or more subsequent requests to the server.
